(19) United States
(12) Patent Application Publication
(10) Pub. No.: US 2026/0121079 A1
(43) Pub. Date: Apr. 30, 2026

(54) METHOD OF MANUFACTURING CARBON SUPPORT WITH IMPROVED POROSITY AND SURFACE HYDROPHOBICITY

(71) Applicants: Hyundai Motor Company, Seoul (KR); Kia Corporation, Seoul (KR)

(72) Inventors: Young Jung Heo, Hwaseong-si (KR); Hee Su Yang, Hwaseong-si (KR); Dae Yong Son, Hwaseong-si (KR); Jong Kil Oh, Hwaseong-si (KR)

(73) Assignees: Hyundai Motor Company, Seoul (KR); KIA Corporation, Seoul (KR)

(21) Appl. No.: 19/051,753

(22) Filed: Feb. 12, 2025

(30) Foreign Application Priority Data
Oct. 30, 2024 (KR) 10-2024-0150247

(51) Int. Cl. H01M 4/88; H01M 4/86; H01M 4/96; H01M 8/1004

(52) U.S. Cl. CPC H01M 4/8817; H01M 4/8657; H01M 4/96; H01M 8/1004

(57) ABSTRACT

A method of manufacturing a carbon support with improved porosity and surface hydrophobicity, in which a carbon support with improved porosity and surface hydrophobicity can be manufactured by activating a carbon support by controlling the pressure factor of an activating gas.

### CROSS-REFERENCE TO RELATED APPLICATION

This application claims, under 35 U.S.C. § 119(a), the benefit of priority from Korean Patent Application No. 10-2024-0150247, filed on Oct. 30, 2024, the entire contents of which are incorporated herein by reference in its entirety.

### BACKGROUND

### (a) Technical Field

The present disclosure relates to a method of manufacturing a carbon support with improved porosity and surface hydrophobicity. In addition, the present disclosure relates to a method of manufacturing a carbon support, in which a carbon support with improved porosity and surface hydrophobicity is, in some embodiments, manufactured by activating a carbon support by controlling the pressure factor of an activating gas.

### (b) Background

An electrode catalyst layer for a proton exchange membrane fuel cell (PEMFC) is composed of a carbon support with platinum, etc., supported thereon and an ionomer as a binder. Notably, platinum and its alloy catalysts, which are anchored on the carbon support, are critical to the overall performance and durability of the fuel cell. The efficacy of these catalysts is significantly influenced by the structural attributes and properties of both the catalyst particles and the carbon support. Therefore, development of optimized catalysts is of paramount importance and urgency for enhancing the performance and durability of hydrogen fuel cell vehicles.

In such fuel cell catalysts, the carbon support serves as an electron conductor that transfers electrons to the catalyst particles, and the carbon support also serves as a support that distributes catalyst nanoparticles in small sizes to enhance catalytic activity. Accordingly, pore characteristics of the carbon support are most directly related to reducing the amount of metal catalyst used to improve fuel cell performance and ensure price competitiveness because catalysts having a size of several nanometers may be evenly distributed while reducing mass transfer resistance in the high current density range.

The activation process is widely recognized as an effective technique for enhancing the porosity of carbon supports, achieved through the oxidation and etching of the carbon surface at elevated temperatures. Generally, activation methods are categorized into two main types: chemical activation, which involves high-temperature heat treatment in conjunction with a chemical agent, and physical activation, which utilizes high-temperature heat treatment with an oxidizing gas such as oxygen, water vapor, or carbon dioxide. Both approaches aim to increase the surface area and porosity of the carbon support, thereby improving its performance in various applications. Chemical activation has the advantage of high activation efficiency, but has economic and environmental problems due to low yield and an additional washing process to remove chemical agents. In contrast, despite having low activation efficiency, physical activation has an economic advantage because it does not require an additional washing process, so research is ongoing to increase the activation efficiency of the physical activation method. In particular, since physical activation is performed by reaction using an oxidizing gas, reactivity of physical activation is easier to control than reactivity of the chemical activation process, which is existing solid reaction, but there remain problems in that the yield is very low due to a decrease in forward reaction rate and activation efficiency with an increase in the concentration of the product over time, and also in that carbon becomes overoxidized, reducing surface durability.

When developing an activation process for fuel cells, it is necessary to simultaneously address surface durability and yield while ensuring adequate porosity. To advance the creation of next-generation carbon supports that effectively balance durability with performance enhancement, there is a pressing need for innovative synthesis strategies that can achieve these critical properties in a balanced manner. The present invention disclosed herein facilitates the development of carbon supports that not only meet the rigorous demands of fuel cell applications, but also have an improved properties related to efficiency, porosity. and durability of the carbon support.

### SUMMARY OF THE DISCLOSURE

The present disclosure addresses the challenges regarding carbon support manufacturing, with the primary objective of providing a method that enhances porosity through the control of pressure circulation. This novel approach aims to significantly improve the performance of electrode catalysts used in fuel cells, thereby contributing to the advancement of fuel cell technology. By focusing on optimizing the structural properties of carbon supports, the methods disclosed herein overcome limitations observed in conventional techniques and enhance the overall efficiency and effectiveness of fuel cell systems.

In some aspects, the present disclosure provides a method of manufacturing a carbon support capable of improving activation efficiency compared to existing methods, thus controlling a pore size, improving porosity, and increasing yield.

In some aspects, the present disclosure provides a method of manufacturing a carbon support capable of not only improving cell performance by enhancing porosity of the carbon support but also increasing durability by improving surface hydrophobicity.

In some aspects, the present disclosure provides a method of manufacturing a carbon support, including activating a carbon support by reacting the carbon support and an activating gas in a pressure circulation control manner.

In some embodiments, the carbon support comprises any one of the following selected from porous carbon, activated carbon, carbon black, carbon nanotubes, graphene, and any combination thereof.

In some embodiments, the activating gas comprises any one of the following selected from air, oxygen (O₂), carbon dioxide (CO₂), water vapor (H₂O), hydrogen peroxide (H₂O₂), ozone (O₃), and any combination thereof.

In some embodiments, the pressure circulation control manner, without wishing to be bound by theory, indicates that the pressure of the activating gas supplied to the carbon support circulates between a lower pressure limit and an upper pressure limit, the lower pressure limit may, in some embodiments, be in a range of 0 bar_{g} to 0.1 bar_{g}, and the upper pressure limit may, in some embodiments, be 0.5 bar_{g} to 1 bar_{g}.

In some embodiments, activating the carbon support is performed at a temperature of 800° C. to 1,200° C. for 0.1 to 6 hours.

In some embodiments, the method includes subjecting the carbon support to oxidation heat treatment, before activating the carbon support.

As such, the oxidation heat treatment, in some embodiments, comprises a process of oxidizing the surface of the carbon support by reaction with an oxidizing gas.

In some embodiments, the oxidizing gas comprises any one of the following selected from air, oxygen (O₂), carbon dioxide (CO₂), water vapor (H₂O), hydrogen peroxide (H₂O₂), ozone (O₃), and any combination thereof.

Furthermore, the oxidation heat treatment, in some embodiments, is performed at a temperature of 150° C. to 600° C. for 0.5 to 5 hours.

In some embodiments, the method further comprises subjecting the activated carbon support to reduction heat treatment, after activating the carbon support.

In some embodiments, the reduction heat treatment comprises a process of reducing the surface of the activated carbon support by reaction with a reducing gas.

In some embodiments, the reducing gas comprises any one of the following selected from hydrogen (H₂), a mixed gas of hydrogen and inert gas, ammonia (NH₃), and any combination thereof.

In some embodiments, the reduction heat treatment is performed at a temperature of 500° C. to 1,100° C. for 0.1 to 6 hours.

Furthermore, the reduction heat treatment comprises, in some embodiments, a process of reducing the surface of the activated carbon support by reacting the activated carbon support and the reducing gas in a pressure circulation control manner.

Here, the pressure circulation control manner of the reducing gas may indicate that the pressure of the reducing gas supplied to the activated carbon support circulates between a lower pressure limit and an upper pressure limit, the lower pressure limit may be 0 bar_{g} to 0.1 bar_{g}, and the upper pressure limit may be 0.5 bar_{g} to 1 bar_{g}.

In some aspects, the present disclosure provides a method of manufacturing a carbon support, including subjecting a carbon support to oxidation heat treatment, activating the pretreated carbon support by reaction with an activating gas, and subjecting the activated carbon support to reduction heat treatment, in which activating the pretreated carbon support comprises activating the carbon support by reacting the carbon support and the activating gas in a pressure circulation control manner.

In some embodiments, a hydrophilic group is formed on the surface of the carbon support by oxidation heat treatment, and in some embodiments, the carbon support is made hydrophobic by removing the hydrophilic group by reduction heat treatment.

In some aspects, the present disclosure provides a catalyst composite for a fuel cell, including a carbon support manufactured by the method described above and a catalytic metal supported on the carbon support.

The details of one or more examples of the disclosure are set forth in the description below. Other features or advantages of the present disclosure will be apparent from the following drawings, detailed description of several examples, and also from the appended claims. The details of the disclosure are set forth in the accompanying description below. Although methods and materials similar or equivalent to those described herein can be used in the practice or testing of the present disclosure, illustrative methods and materials are now described. Other features, objects, and advantages of the disclosure will be apparent from the description and from the claims. In the specification and the appended claims, the singular forms also include the plural unless the context clearly dictates otherwise. Unless defined otherwise, all technical and scientific terms used herein have the same meaning as commonly understood by one of ordinary skill in the art to which this disclosure belongs.

### BRIEF DESCRIPTION OF THE DRAWINGS

FIG. 1 is a graph showing activation efficiency upon activation of a carbon support under the condition that the pressure of an activating gas is maintained constant.

FIG. 2 is a graph showing activation efficiency upon reaction of a carbon support and an activating gas under the condition that the pressure of the activating gas is controlled in the system where reaction occurs according to the present disclosure.

FIG. 3 shows a process of converting the carbon support surface oxidized through activation into a hydrophobic surface by reduction heat treatment.

FIG. 4 shows transmission electron microscope images of carbon supports according to Comparative Example 1 and Example 5.

FIG. 5 shows transmission electron microscope images of carbon supports according to Comparative Example 4 and Example 7.

FIG. 6 schematically shows the crystal structure of carbon to explain the vertical crystallite size of the carbon support.

FIG. 7 shows results of analysis of gas adsorption of carbon supports according to Comparative Example 1 and Examples 1 to 4.

FIG. 8 shows desorption curves of the carbon supports according to Comparative Example 1 and Examples 1 to 4.

FIG. 9 shows results of analysis of gas adsorption of carbon supports according to Comparative Example 4 and Examples 6 and 7.

FIG. 10 shows desorption curves of the carbon supports according to Comparative Example 4 and Examples 6 and 7.

FIG. 11 shows results of analysis of water adsorption and desorption capacities of the carbon supports according to Comparative Example 4 and Examples 6 and 7.

FIG. 12 shows durability test conditions of membrane-electrode assemblies using Comparative Example 1 and Example 5.

FIG. 13 shows results of a durability test conducted under low temperature, high humidity, and pressurized conditions on the membrane-electrode assemblies using Comparative Example 1 and Example 5.

FIG. 14 shows the durability degradation rate based on the durability test results according to FIG. 13.

FIG. 15 shows results of a durability test conducted under high temperature, low humidity, and pressurized conditions on the membrane-electrode assemblies using Comparative Example 1 and Example 5.

FIG. 16 shows the durability degradation rate based on the durability test results according to FIG. 15.

FIG. 17 shows the durability test conditions of membrane-electrode assemblies using Comparative Example 4 and Example 7.

FIG. 18 shows results of a durability test conducted under low temperature, high humidity, and pressurized conditions on the membrane-electrode assemblies using Comparative Example 4 and Example 7.

FIG. 19 shows the durability degradation rate based on the durability test results according to FIG. 18.

FIG. 20 shows results of a durability test conducted under high temperature, low humidity, and pressurized conditions on the membrane-electrode assemblies using Comparative Example 4 and Example 7.

FIG. 21 shows the durability degradation rate based on the durability test results according to FIG. 20.

### DETAILED DESCRIPTION

The above and other objects, features and advantages of the present disclosure will be more clearly understood from the following embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

In some aspects, the present disclosure relates to a method of manufacturing a carbon support including activating a carbon support by reacting the carbon support with an activating gas in a pressure circulation control manner.

In some embodiments, the method of manufacturing a carbon support according to the present disclosure optionally includes subjecting the carbon support to oxidation heat treatment before activating the carbon support.

In some embodiments, the method of manufacturing a carbon support according to the present disclosure optionally includes subjecting the activated carbon support to reduction heat treatment after activating the carbon support.

Individual steps are described in detail below.

Activation A carbon support is generally used as a support for a catalyst for a fuel cell. In some embodiments, activating the carbon support is performed to increase the efficiency of loading a catalytic metal onto the carbon support.

Activating the carbon support may be a process of oxidizing the surface of the carbon support using an activating gas. During this process, hydrophilic groups such as —OH groups, —COOH groups, etc. may be formed on the surface of the carbon support.

In one embodiment, the activating gas comprises any one of the following selected from air, oxygen (O₂), carbon dioxide (CO₂), water vapor (H₂O), hydrogen peroxide (H₂O₂), ozone (O₃), and any combination thereof. In addition, any gas that has oxidizing properties and is able to oxidize the surface of the carbon support may be used without particular limitation.

When carbon dioxide or water vapor is used as the activating gas, the following reaction may occur on the surface of the carbon support.

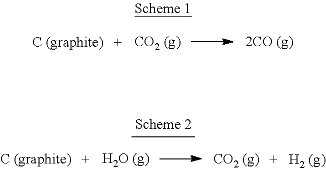

Here, the activation efficiency of the carbon support may be affected by the pressure of the activating gas in the system where activation reaction occurs according to Le Chatelier's principle, which will be described more specifically using Scheme 1.

The reaction index Q of Scheme 1 may be defined as follows.

$$Q = \frac{{[ CO ]}^{2}}{[ {CO}_{2} ]}$$

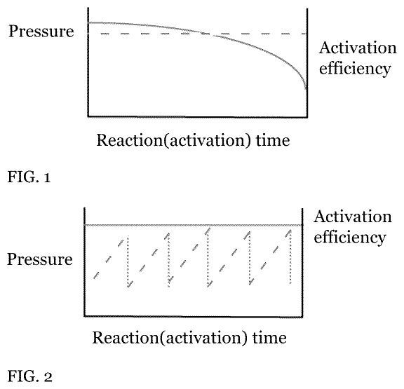

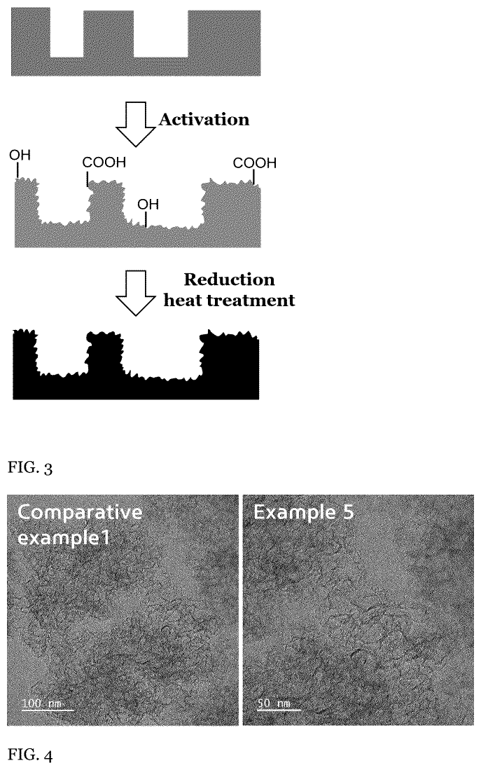

When the pressure of the activating gas supplied to the carbon support is constant, the denominator of the reaction index Q, [CO₂], is fixed, and the numerator of the reaction index, [CO]², increases as reaction progresses. Thereby, the reaction index Q increases and a difference with equilibrium index Kc decreases, so forward reaction decreases. Accordingly, the activation efficiency may decrease, as shown in FIG. 1.

Activating the carbon support according to the present disclosure optionally includes a process of reacting the carbon support and the activating gas in a pressure circulation control manner. The pressure circulation control manner indicates that the amount of activating gas injected into a predetermined space, such as a chamber or tank, where a carbon support and an activating gas react is maintained while the discharged amount thereof is controlled, so that the pressure of the activating gas in the system where reaction occurs increases and decreases repeatedly, as shown in FIG. 2. In addition, the pressure of the activating gas in the system where reaction occurs may be controlled by pulse-injecting the activating gas into the carbon support.

Specifically, according to the pressure circulation control manner, the pressure of the activating gas supplied to the carbon support may be applied to the system where reaction occurs so as to circulate between a lower pressure limit and an upper pressure limit. More specifically, the pressure of the activating gas may be continuously or discontinuously increased from a level equal to the lower pressure limit to reach a pressure equal to the upper pressure limit, and then the pressure may be continuously or discontinuously decreased to become equal to the lower pressure limit again. This process may be repeated during activation of the carbon support.

The lower pressure limit may be 0 bar_{g} to 0.1 bar_{g}, and the upper pressure limit may be 0.5 bar_{g} to 1 bar_{g}. For example, activating gas may be supplied so that the pressure thereof repeatedly circulates between 0 bar_{g} to 1 bar_{g}, preferably between 0.1 bar_{g} to 0.5 bar_{g}. If the lower pressure limit of the activating gas is too low, the activation efficiency may excessively decrease, and if the upper pressure limit thereof is too high, overoxidation may occur during activation, lowering the activation efficiency and yield.

As shown in FIG. 2, when the pressure of the activating gas is controlled by adjusting the amount of discharged activating gas while maintaining the amount of injected activating gas, [CO₂], which is the denominator of the reaction index Q, is fixed, and [CO], which is the numerator of the reaction index, repeatedly decreases as reaction progresses. Thereby, the reaction index Q decreases periodically and a difference with equilibrium index Kc is maintained constant, so forward reaction may be dominant and the activation efficiency may be improved.

In this way, the method of manufacturing a carbon support according to the present disclosure is capable of inducing an improvement in porosity by increasing the specific surface area and roughness of the carbon support surface and enlarging the pore size by reacting the carbon support and the activating gas in a pressure circulation control manner.

In this way, loading efficiency and mass transfer of the metal catalyst is improved due to the carbon support surface with controlled porosity.

In some embodiments, the carbon support comprises any one of the following selected from porous carbon, activated carbon, carbon black, carbon nanotubes, graphene, and any combination thereof. Moreover, the carbon support comprises, in some embodiments, mesoporous carbon, examples of which include high-porosity mesoporous carbon and high-crystallinity mesoporous carbon. In addition, any carbon material that is conductive may be used without particular limitation.

In some embodiments, activating the carbon support is performed at a temperature of 800° C. to 1,200° C. for 0.1 hour to 6 hours.

In some embodiments, activating the carbon support is performed at a temperature of 900° C. to 1,100° C. If the activation temperature is less than 900° C., the activation efficiency may decrease, whereas if the activation temperature exceeds 1,100° C., the surface of the carbon support may be overoxidized and the yield may be lowered.

Also, activating the carbon support is, in some embodiments, performed for 0.5 to 2 hours. If the activation time is less than 0.5 hours, the activation efficiency on the surface of the carbon support may decrease and the porosity may not be sufficiently improved, whereas if the activation time exceeds 2 hours, the surface of the carbon support may be overoxidized and the yield may be lowered.

### Oxidation Heat Treatment

Meanwhile, conducting the activation process directly on the carbon support without prior oxidation heat treatment leads to low activation efficiency of the carbon surface. This inefficiency arises from the high acid resistance associated with the reduced reactivity of the carbon surface, which can result in prolonged activation times and diminished yields. Therefore, optimizing the activation process by incorporating oxidation heat treatment is essential to enhance the reactivity of the carbon support, thereby improving both activation efficiency and overall yield in the manufacturing process.

Accordingly, in order to improve the efficiency of activation of the carbon support, oxidation heat treatment is further performed before activating the carbon support. The oxidation heat treatment, in some embodiments, comprises a process of oxidizing the surface of the carbon support by reaction with an oxidizing gas.

In addition to the oxidizing gas, treatments such as wet acid treatment or dry oxidation methods—including ozone and plasma treatments—are also viable options for enhancing carbon support properties. However, when employing gas-phase reactions, there is a tendency for the carbon support surface to undergo uniform oxidation. This uniform oxidation allows for the subsequent activation of the carbon support to be performed immediately after the oxidation heat treatment, thereby significantly improving process efficiency. By integrating these treatment methods, it is possible to optimize the characteristics of the carbon support, ultimately enhancing its performance in various applications.

In some embodiments, the oxidizing gas comprises any one of the following selected from air, oxygen (O₂), carbon dioxide (CO₂), water vapor (H₂O), hydrogen peroxide (H₂O₂), ozone (O₃), and any combination thereof. In addition, any gas that has oxidizing properties and is able to oxidize the surface of the carbon support may be used without particular limitation.

The oxidation heat treatment may be performed at a temperature range of 150° C. to 600° C. for 0.5 to 5 hours.

In some embodiments, the oxidation heat treatment is performed at a temperature range of 200° C. to 400° C. Also, the oxidation heat treatment is preferably performed for 0.5 to 2 hours. If the oxidation heat treatment temperature is less than 150° C., or the oxidation heat treatment time is less than 0.5 hours, oxidation may not occur properly on the surface of the carbon support. On the other hand, if the oxidation heat treatment temperature exceeds 600° C., or the oxidation heat treatment time exceeds 5 hours, not only the surface but also the inside of the carbon support may be overoxidized, which may lower the activation efficiency and yield.

### Reduction Heat Treatment

When the carbon support undergoes oxidation heat treatment or activation, its surface can become oxidized, leading to the formation of hydrophilic functional groups. These modifications can compromise the structural integrity of the carbon support, making it more susceptible to reactions with various external substances. This increased vulnerability can adversely affect the robustness of the carbon support, potentially diminishing its overall performance and durability in practical applications. Therefore, it is crucial to carefully balance the benefits of oxidation with the need to maintain the mechanical stability of the carbon support.

Accordingly, additional heat treatment is performed to improve surface robustness of the activated carbon support. More specifically, a process of reducing the surface of the activated carbon support by reaction with a reducing gas is performed. When the surface of the activated carbon support is reacted with a reducing gas, the hydrophilic groups formed on the surface of the carbon support may be removed and the surface of the carbon support may be converted into a hydrophobic surface. Accordingly, excellent robustness and durability is obtained while maintaining improved porosity of the carbon support.

In some embodiments, the reducing gas comprises any one of the following selected from hydrogen (H₂), a mixed gas of hydrogen and inert gas (e.g., gas of Group 18 on the periodic table), ammonia (NH₃), and any combination thereof. In addition, any gas that has reducing properties may be used without particular limitation.

Also, the reduction heat treatment comprises, in some embodiments, a process of reducing the surface of the activated carbon support by reacting the activated carbon support and the reducing gas in a pressure circulation control manner.

As such, reacting the reducing gas in a pressure circulation control manner indicates that the pressure of the reducing gas supplied to the activated carbon support circulates between a lower pressure limit and an upper pressure limit, the lower pressure limit may be 0 bar_{g} to 0.1 bar_{g}, and the upper pressure limit may be 0.5 bar_{g} to 1 bar_{g}.

A detailed description thereof will be omitted because it is substantially the same as that described in activating the carbon support above, except for the type of gas.

In some embodiments, the reduction heat treatment is performed at a temperature range of 500° C. to 1,100° C. for 0.1 hour to 6 hours.

In some embodiments, the reduction heat treatment is performed at a temperature range of 700° C. to 900° C. If the reduction heat treatment temperature is less than 700° C., the reduction efficiency may decrease, whereas if the reduction heat treatment temperature exceeds 900° C., the pore structure may collapse due to excessively high temperature.

Also, the reduction heat treatment is, in some embodiments, performed for 0.5 to 2 hours. If the reduction heat treatment time is less than 0.5 hours, reduction may not occur completely, whereas if it exceeds 2 hours, the pore structure may collapse.

### Catalyst Composite for Fuel Cell

Another aspect of the present disclosure relates to a catalyst composite for a fuel cell, including a carbon support manufactured by the manufacturing method described above and a catalytic metal supported on the carbon support.

The catalytic metal may be used without particular limitation so long as it is commonly used in the art to which the present disclosure pertains, and for example, the catalytic metal comprises, in some embodiments at least one of the following selected from platinum (Pt), gold (Au), silver (Ag), rhodium (Rh), nickel (Ni), cobalt (Co), iron (Fe), palladium (Pd), copper (Cu), iridium (Ir), osmium (Os), molybdenum (Mo), vanadium (V), and any combination thereof.

In some embodiments, the catalytic metal may optionally be included in an amount of 10 to 50 wt % based on the total weight of the catalyst composite. If the amount of the catalytic metal is less than 10 wt %, the catalyst's density may be insufficient, leading to suboptimal performance. Conversely, when the metal content exceeds 50 wt %, the proximity between catalyst particles becomes too close, resulting in an excessive concentration of catalyst material. This overabundance can hinder the formation of platinum-heterogeneous element bonding, which is crucial for enhancing the durability of the catalyst. Therefore, it is essential to carefully optimize the catalytic metal loading within this range to achieve a balance that maximizes both the effectiveness and longevity of the catalyst.

Any method for supporting the catalytic metal on the carbon support may be used so long as it is a synthesis method that allows a platinum catalyst or other catalytic metal salt to interact with the surface doping layer of the carbon support, and typical examples of the catalyst synthesis method comprise, in some embodiments, impregnation, a polyol method, incipient wetness impregnation, and the like.

The catalyst composite including the carbon support manufactured according to the present disclosure and the catalytic metal may be applied to an electrode for a fuel cell.

This disclosure is further illustrated by the following non-limiting examples.

### Example 1

As a carbon support, high-porosity mesoporous carbon having a specific surface area of about 600 to 700 m²/g, a total pore volume of about 1.7 to 1.8 cm³/g, and a mesopore volume of about 1.00 cm³/g was prepared.

The carbon support was activated by reaction with carbon dioxide gas. More specifically, the carbon support was placed in a reaction chamber, and carbon dioxide gas and nitrogen gas were supplied to the reaction chamber at 200 sccm and 100 sccm, respectively. As such, the carbon support was activated in a pressure circulation control manner by controlling the amount of discharged carbon dioxide gas so that the pressure of carbon dioxide gas in the reaction chamber circulated between a lower pressure limit of 0.2 bar_{g} and an upper pressure limit of 0.5 bar_{g}. Also, the activation process was performed at 900° C. for 1 hour.

A carbon support according to Example 1 was manufactured through such activation.

### Example 2

A carbon support according to Example 2 was manufactured in the same manner as in Example 1, with the exception that the prepared high-porosity mesoporous carbon was subjected to oxidation heat treatment under air conditions at about 250° C. for 1 hour followed by activation. More specifically, the air was supplied at a flow rate of 300 sccm.

### Example 3

A carbon support according to Example 3 was manufactured in the same manner as in Example 2, with the exception that the activation process was performed for 2 hours.

### Example 4

A carbon support according to Example 4 was manufactured in the same manner as in Example 2, with the exception that the activation process was performed at about 1,000° C.

### Example 5

After manufacturing the carbon support according to Example 4, the carbon support was subjected to reduction heat treatment with a mixed gas of 3% hydrogen (H₂)/97% argon (Ar). More specifically, the mixed gas was supplied at a flow rate of 300 sccm. As such, the carbon support was subjected to reduction heat treatment in a pressure circulation control manner by controlling the amount of discharged mixed gas so that the pressure of the mixed gas in the reaction chamber circulated between a lower pressure limit of 0.2 bar_{g} and an upper pressure limit of 0.5 bar_{g}. Also, the reduction heat treatment process was performed at about 900° C. for 1 hour. A carbon support according to Example 5 was manufactured through such oxidation heat treatment, activation, and reduction heat treatment.

### Example 6

As a carbon support, high-crystallinity mesoporous carbon having a specific surface area of about 200 to 400 m²/g, a total pore volume of about 1.7 to 1.8 cm³/g, and a mesopore volume of about 1.00 cm³/g was prepared.

The carbon support was subjected to oxidation heat treatment under air conditions at about 250° C. for 1 hour. Thereafter, the pretreated carbon support was activated by reaction with carbon dioxide gas. As such, the carbon support was activated in a pressure circulation control manner by controlling the amount of discharged carbon dioxide gas so that the pressure of carbon dioxide gas in the reaction chamber circulated between a lower pressure limit of 0.2 bar_{g} and an upper pressure limit of 0.5 bar_{g}. Also, the activation process was performed at 1,000° C. for 1 hour.

A carbon support according to Example 6 was manufactured through such oxidation heat treatment and activation.

### Example 7

After manufacturing the carbon support according to Example 6, the carbon support was subjected to reduction heat treatment with a mixed gas of 3% hydrogen (H₂)/97% argon (Ar). As such, the carbon support was subjected to reduction heat treatment in a pressure circulation control manner by controlling the amount of discharged mixed gas so that the pressure of the mixed gas in the reaction chamber circulated between a lower pressure limit of 0.2 bar_{g} and an upper pressure limit of 0.5 bar_{g}. Also, the reduction heat treatment process was performed at about 900° C. for 1 hour.

A carbon support according to Example 7 was manufactured through such oxidation heat treatment, activation, and reduction heat treatment.

### Comparative Example 1

High-porosity mesoporous carbon having a specific surface area of about 600 to 700 m²/g, a total pore volume of about 1.7 to 1.8 cm³/g, and a mesopore volume of about 1.00 cm³/g was prepared as a carbon support according to Comparative Example 1.

### Comparative Example 2

The carbon support prepared in Comparative Example 1 was activated by reaction with carbon dioxide gas. As such, the activation process was carried out at a gauge pressure of 0 bar_{g} (atmospheric pressure). Also, the activation process was performed at 900° C. for 1 hour.

A carbon support according to Comparative Example 2 was manufactured through such activation.

### Comparative Example 3

The carbon support prepared in Comparative Example 1 was activated by reaction with carbon dioxide gas. As such, the activation process was carried out at a gauge pressure maintained at 0.5 bar_{g}. Also, the activation process was performed at 900° C. for 1 hour.

### Comparative Example 4

High-crystallinity mesoporous carbon having a specific surface area of about 200 to 400 m²/g, a total pore volume of about 1.7 to 1.8 cm³/g, and a mesopore volume of about 1.00 cm³/g was prepared as a carbon support according to Comparative Example 4.

### Test Example 1—Surface Component Analysis Using XPS

To determine the surface components of the carbon supports according to Examples 1 to 7 and Comparative Examples 1 to 4, XPS (X-ray photoelectron spectroscopy) was performed. The results thereof are shown in Table 1 below.

TABLE 1

| Elemental | | | | | | | | | | | |
|---|---|---|---|---|---|---|---|---|---|---|---|
| content | Comparative Example | | | | Example | | | | | | |
| (at. %) | 1 | 2 | 3 | 4 | 1 | 2 | 3 | 4 | 5 | 6 | 7 |
| C | 92.4 | 89.3 | 84.8 | 97.6 | 91.3 | 89.4 | 89.0 | 88.7 | 94.4 | 95.7 | 97.6 |
| O | 7.2 | 10.4 | 15.1 | 2.3 | 8.5 | 10.5 | 10.9 | 11.2 | 5.5 | 4.1 | 2.4 |
| Others | 0.4 | 0.3 | 0.1 | 0.1 | 0.2 | 0.1 | 0.1 | 0.1 | 1 | 0.2 | 0 |

Referring to Table 1, when comparing Comparative Example 1 with Example 4 and Comparative Example 4 with Example 6, which used the same type of carbon support and had differences in oxidation heat treatment and activation, surface oxidation occurred after the pore activation process, confirming that the oxygen content on the surface of the carbon support increased.

Also, in Examples 5 and 7 in which reduction heat treatment was performed, the oxygen content on the surface of the carbon support was confirmed to decrease after reduction. In particular, when comparing Comparative Example 1 with Example 5, and Comparative Example 4 with Example 7, the oxygen content on the surface of the carbon support was measured to be similar to that before treatment.

### Test Example 2—Surface Structure Analysis Using TEM

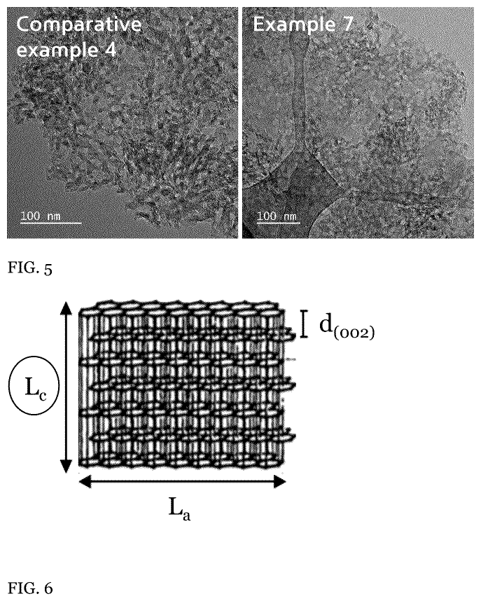

In order to analyze the surface structures of the manufactured carbon supports, the carbon supports according to Comparative Example 1 and Example 5, and Comparative Example 4 and Example 7 were photographed using TEM, and are shown in FIGS. 4 and 5, respectively.

Referring to FIGS. 4 and 5, the carbon support according to Comparative Example 1 was confirmed to be carbon with a very thin carbon surface layer to the level of about 1 to 2 nm. The high-crystallinity mesoporous carbon of Comparative Example 4 was confirmed to be carbon with a thick graphite layer to the level of 3 nm or more.

In addition, when comparing Comparative Example 1 with Example 5, and Comparative Example 4 with Example 7, the structure and porosity were maintained even after performing oxidation heat treatment, activation, and reduction heat treatment.

### Test Example 3—Lattice Structure Analysis Using XRD

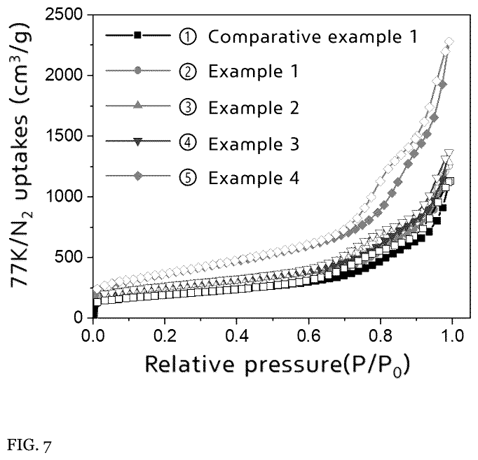

To analyze the structures of the carbon supports according to Examples 1 to 7 and Comparative Examples 1 to 4, XRD (X-ray diffraction) was performed. As such, the L_{c(002)} value, which represents the vertical crystallite size that is an indicator of the durability of the carbon support, was calculated from the results of XRD, as shown in FIG. 6, and the L_{c(002)} value was calculated using the Scherrer equation. The results thereof are shown in Table 2 below.

TABLE 2

| Classification | L_{c(002)} (nm) |
|---|---|
| Comparative Example 1 | 1.6 |
| Comparative Example 2 | 1.5 |
| Comparative Example 3 | 1.2 |
| Comparative Example 4 | 4.0 |
| Example 1 | 1.6 |
| Example 2 | 1.5 |
| Example 3 | 1.5 |
| Example 4 | 1.4 |
| Example 5 | 1.4 |
| Example 6 | 3.9 |
| Example 7 | 3.9 |

Referring to Table 2, when comparing Comparative Example 3, in which the carbon support was activated while maintaining the pressure of carbon dioxide gas constant, with Example 5, in which oxidation heat treatment, activation, and reduction heat treatment according to the present disclosure were performed, Example 5 had a higher L_{c(002)} value, confirming higher durability and efficient activation.

In addition, Comparative Example 4 using high-crystallinity mesoporous carbon and Examples 6 and 7 in which oxidation heat treatment, activation, and/or reduction heat treatment were performed thereon had similar L_{c(002)} values. Accordingly, the activation efficiency of the carbon support was excellent regardless of the type of carbon used.

### Test Example 4—Porosity Analysis Using 77K/N₂ Gas Adsorption

To analyze the surface porosity of the manufactured carbon support, 77K/N₂ gas adsorption analysis was performed on Examples 1 to 5 and Comparative Examples 1 to 3. Also, the specific surface area (S_{BET}) was determined using the Brunauer-Emmett-Teller (BET) equation, the total pore volume (Vₜₒₜ) was obtained using the adsorption curve of relative pressure up to 0.990, and the mesopore volume (Vₘₑₛₒ) was obtained using the value of the desorption curve by the Barret-Joyner-Halenda (BJH) method. As such, the micropore size was obtained by calculating the pore volume of 2 nm or less from the pore distribution using the non-local density functional theory (NLDFT) method. Moreover, the pore size was determined using the mode of the pore distribution and the weight average value thereof.

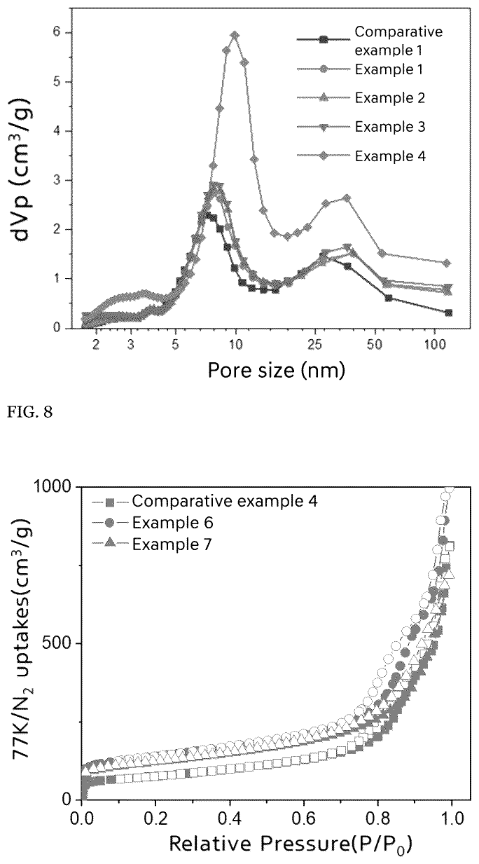

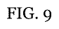

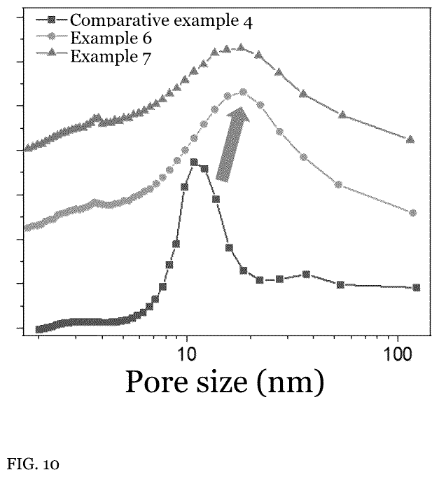

The results thereof were described separately for Comparative Examples 1 to 3 and Examples 1 to 5, and Comparative Example 4 and Examples 6 and 7, depending on the type of carbon support used. The results of Comparative Examples 1 to 3 and Examples 1 to 5 are shown in Table 3 below and FIGS. 7 and 8, and the results of Comparative Example 4 and Examples 6 and 7 are shown in Table 4 below and FIGS. 9 and 10.

TABLE 3

| | | | | | Pore | | | |
|---|---|---|---|---|---|---|---|---|
| | | | | | size | | | |
| | | | | | (weight | | | |
| | S_{BET} | Vₜₒₜ | V_{micro} | Vₘₑₛₒ | average) | | L_{c(002)} | Yield |
| Sample | (m²/g) | (cm³/g) | (cm³/g) | (cm³/g) | (nm) | | (nm) | (%) |
| Comparative | 678 | 1.75 | 0.10 | 1.01 | 7.0 | (11.2) | 1.6 | — |
| Example 1 | | | | | | | | |
| Example 1 | 850 | 1.95 | 0.18 | 1.58 | 8.0 | (11.8) | 1.6 | >95 |
| Example 2 | 916 | 1.99 | 0.20 | 1.61 | 8.1 | (11.4) | 1.5 | >93 |
| Example 3 | 964 | 2.12 | 0.21 | 1.69 | 8.0 | (11.6) | 1.5 | >85 |
| Example 4 | 1311 | 3.54 | 0.52 | 2.96 | 9.45 | (12.2) | 1.4 | >50 |
| Example 5 | 1288 | 3.36 | 0.49 | 2.81 | 8.9 | (11.7) | 1.4 | >50 |
| Comparative | 650 | 1.69 | 0.10 | 0.99 | 7.2 | (11.0) | 1.5 | >98 |
| Example 2 | | | | | | | | |
| Comparative | 820 | 1.93 | 0.18 | 1.42 | 7.6 | (11.5) | 1.2 | <30 |

Example 3

Referring to Table 3 and FIGS. 7 and 8, in the carbon support subjected to at least one of oxidation heat treatment, activation, or reduction heat treatment according to the present disclosure, the efficiency of porosity development, the extent of carbon durability degradation, and the yield were superior compared to Comparative Example 2 in which activation treatment was performed using carbon dioxide gas without pressure or Comparative Example 3 in which activation treatment was performed while maintaining the pressure constant. Also, by appropriately controlling the conditions of oxidation heat treatment, activation, and reduction heat treatment, such as the oxidation heat treatment temperature and time, the activation temperature, etc., not only an improvement in porosity but also fine control of the pore size were possible.

TABLE 4

| | | | Pore size | | |
|---|---|---|---|---|---|
| | S_{BET} | Vₘₑₛₒ | (weight average) | L_{c(002)} | Yield |
| Sample | (m²/g) | (cm³/g) | (nm) | (nm) | (%) |
| Comparative | 274 | 0.98 | 10.7 (12.4) | 4.0 | — |
| Example 4 | | | | | |
| Example 6 | 454 | 1.20 | 14.4 (15.3) | 3.9 | >90 |
| Example 7 | 441 | 1.12 | 13.2 (14.7) | 3.9 | >90 |

Referring to Table 4 and FIGS. 9 and 10, in Examples 6 and 7 in which at least one of oxidation heat treatment, activation, or reduction heat treatment was performed on the high-crystallinity mesoporous carbon support according to the present disclosure, the porosity was improved compared to Comparative Example 4. Also, the improved porosity was maintained even after reduction heat treatment.

### Test Example 5−Analysis of Water Adsorption Capacity

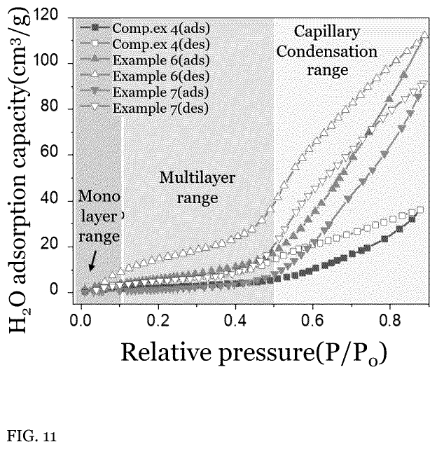

The water adsorption capacity was analyzed for Comparative Example 4 and Examples 6 and 7 using high-crystallinity mesoporous carbon as a carbon support. The results thereof are shown in Table 5 below and FIG. 11. The water adsorption capacity was analyzed by measuring the adsorption capacity while injecting H₂O (vapor) from low pressure at 298 K using a BET device.

TABLE 5

| | Oxygen | Water adsorption capacity (adsorption/desorption) | |
|---|---|---|---|
| | content | (cm³/g) | |
| Sample | (at. %) | Relative pressure 0.1 | Relative pressure 0.5 |
| Comparative | 2.3 | 1.6/3.7 | 5.5/14.6 |
| Example 4 | | | |
| Example 6 | 4.0 | 4.0/9.1 | 17.7/41.5 |
| Example 7 | 2.4 | 0.8/3.4 | 8.2/16.3 |

Referring to Table 5 and FIG. 11, in Example 6 in which activation treatment was performed, the water adsorption capacity was at least doubled compared to Comparative Example 4. This is deemed to be due to the effect of increasing hydrophilicity resulting from introduction of oxygen functional groups to the surface of the carbon support. Also, in Example 7 in which reduction heat treatment was performed, the initial water adsorption capacity decreased compared to Comparative Example 4, confirming that the surface became hydrophobic. This may lead to improved durability by suppressing interaction with water molecules participating as a reactant in an MEA catalyst durability test.

### Test Example 6—Analysis of Membrane-Electrode Assembly (MEA) Cell Performance and Catalyst Durability

After manufacturing a catalyst composite using each of the carbon supports according to Comparative Example 1 and Example 5 and the carbon supports according to Comparative Example 4 and Examples 6 and 7, a membrane-electrode assembly including the catalyst composite was manufactured.

Specifically, platinum was supported on the carbon support using a known polyol process. As such, the amount of platinum was set to 30 wt % based on the total weight of the catalyst composite.

Nafion (Du Pont) as an electrolyte membrane, a cathode slurry including the catalyst composite manufactured using each of the carbon supports according to Comparative Example 1 and Example 5 and the carbon supports according to Comparative Example 4 and Example 7, an anode slurry including a known Pt/C catalyst composite, carbon paper as a gas diffusion layer, and a separator with a flow field formed therein were prepared. A cathode was formed by applying the cathode slurry onto one side of the electrolyte membrane followed by drying, and an anode was formed by applying the anode slurry onto the remaining side thereof followed by drying. Thereafter, a membrane-electrode assembly (MEA) cell was manufactured by sequentially stacking the gas diffusion layer and the separator with a flow field formed therein on each of the cathode and the anode.

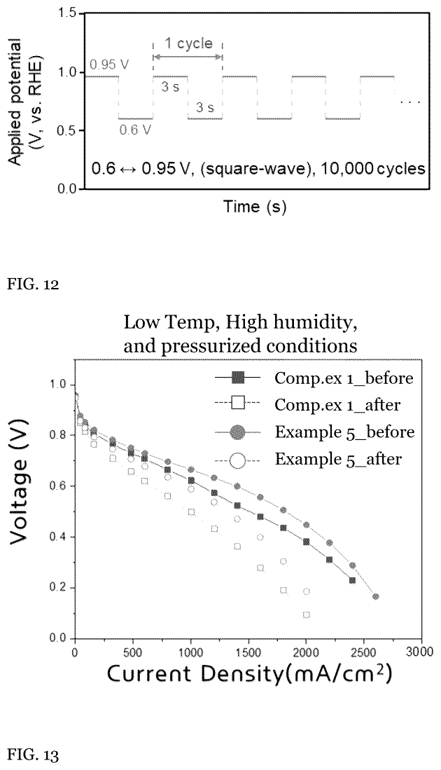

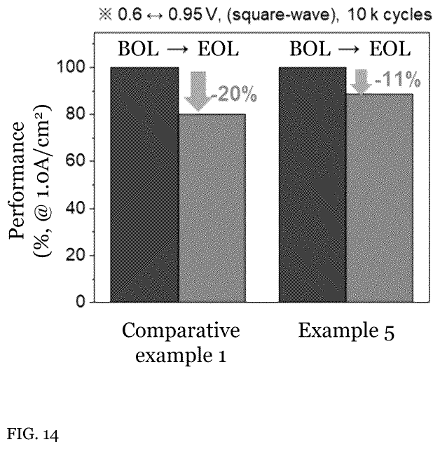

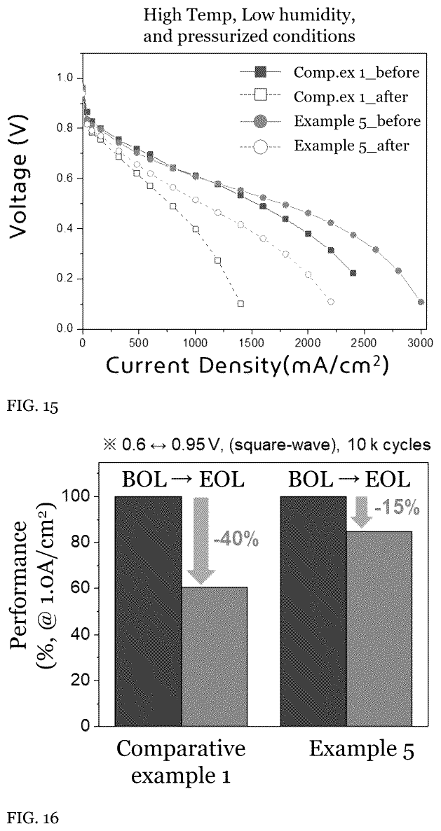

A durability test was performed on the membrane-electrode assembly cells using the carbon supports according to Comparative Example 1 and Example 5 by repeating 10,000 cycles of charge and discharge under the conditions of FIG. 12. As such, the durability test was separately performed under low temperature, high humidity (60° C., RH50% or higher), and pressurized (1 barₐ or higher) conditions and under high temperature, low humidity (80° C., less than RH50%), and pressurized (1 barₐ or higher) conditions. The electrochemical performance and catalyst durability degradation rate before and after the durability test performed under low temperature and high humidity conditions are shown in FIGS. 13 and 14, respectively. Also, the electrochemical performance and catalyst durability degradation rate before and after the durability test performed under high temperature and low humidity conditions are shown in FIGS. 15 and 16, respectively.

Based on results of evaluation of cell performance, initial performance before the durability test was further improved in Example 5 in which activation was performed. This is deemed to be due to increased cell performance resulting from improved catalyst distribution and mass transfer by virtue of improved porosity.

Also, when comparing the results before/after an accelerated durability test inducing Pt elution, the durability degradation rate of the catalyst subjected to porosity improvement treatment (Example 5) was reduced compared to the catalyst using the conventional carbon support (Comparative Example 1).

In particular, the durability degradation rate was greatly reduced (40→15%) under high temperature and low humidity conditions. This is deemed to be due to decreased Pt elution and decreased particle coarsening through improvement in the specific surface area of the carbon support and hydrophobicity of the carbon surface.

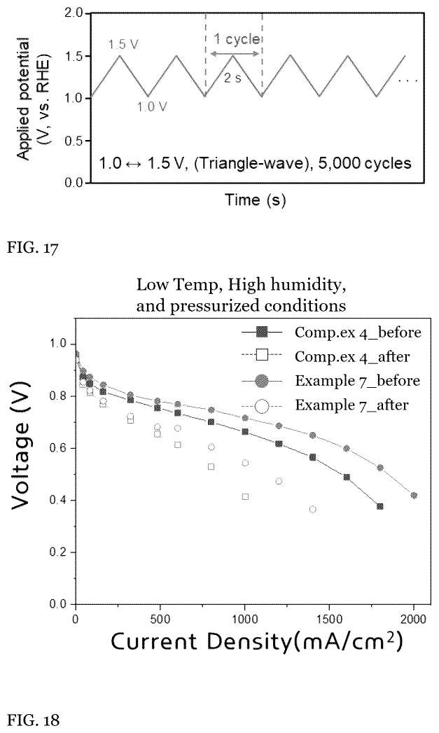

In addition, a durability test was performed on the membrane-electrode assembly cells using the carbon supports according to Comparative Example 4 and Examples 6 and 7 by repeating 5,000 cycles of charge and discharge under the conditions of FIG. 17. As such, the durability test was separately performed under low temperature, high humidity, and pressurized conditions and under high temperature, low humidity, and pressurized conditions as described above.

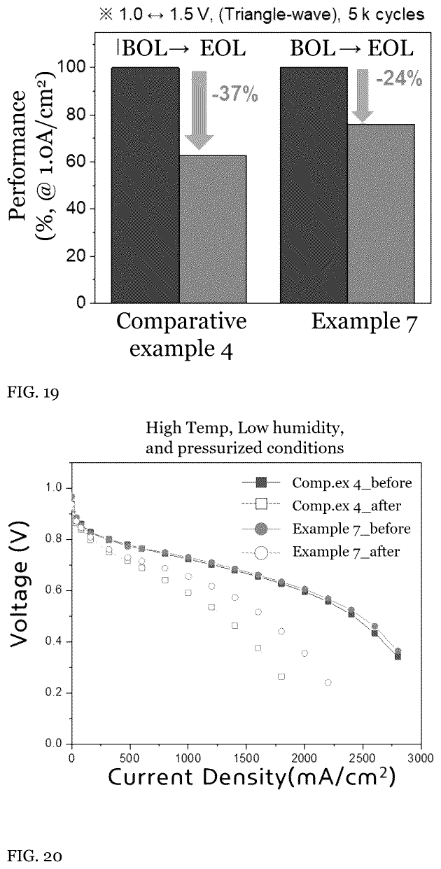

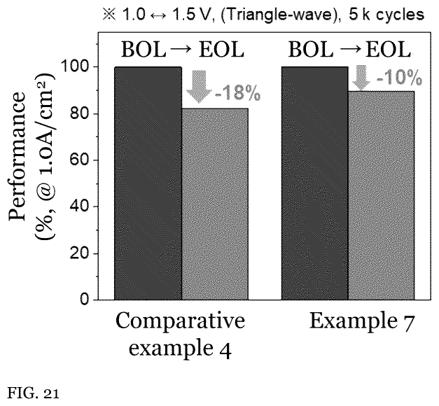

The electrochemical performance and catalyst durability degradation rate before and after the durability test performed under low temperature and high humidity conditions on the membrane-electrode assembly cells using Comparative Example 4 and Example 7 are shown in FIGS. 18 and 19, respectively. In addition, the electrochemical performance and catalyst durability degradation rate before and after the durability test performed under high temperature and low humidity conditions on the membrane-electrode assembly cells using Comparative Example 4 and Example 7 are shown in FIGS. 20 and 21, respectively.

Table 6 below shows the results of FIGS. 18 to 21, including the results of Example 6.

TABLE 6

| | Degradation rate after | Degradation rate after |
|---|---|---|
| | carbon durability test (%) | carbon durability test (%) |
| | (low temperature and | (high temperature and |
| Classification | high humidity) | low humidity) |
| Comparative | 37 | 18 |
| Example 4 | | |
| Example 6 | 40 | 30 |
| Example 7 | 24 | 10 |

Based on results of evaluation of cell performance, initial performance before the durability test of the cells using Comparative Example 4 and Example 7 showed that the cell after activation exhibited better performance. This is deemed to be due to increased cell performance resulting from improved catalyst distribution and mass transfer by virtue of improved porosity.

Also, the durability degradation rate was accelerated in the catalyst (Example 6) using the carbon support on which pore activation was performed compared to the catalyst using Comparative Example 4.

This is deemed to be due to a decrease in carbon surface durability (L_{c}) caused by surface oxidation during pore activation and an increase in hydrophilicity owing to surface oxygen functional groups. Thereafter, through surface reduction as in Example 7, the carbon surface durability was improved, and hydrophobicity was improved by removal of oxygen functional groups, thereby improving the carbon corrosion durability results. This is deemed to be due to improved corrosion durability resulting from the improved carbon surface hydrophobicity.

As is apparent from the foregoing, a method of manufacturing a carbon support according to the present disclosure is capable of controlling the pore size of the carbon support surface and inducing an improvement in porosity by reaction of a carbon support and an activating gas in a pressure circulation control manner. Moreover, a hydrophobic carbon support with a finely controlled pore size of the carbon support surface can be provided.

In this way, loading efficiency and mass transfer of the metal catalyst can be improved due to the carbon support surface with controlled porosity, and also the catalyst durability can be enhanced by virtue of improved hydrophobicity of the carbon support surface.

The effects of the present disclosure are not limited to the foregoing. It should be understood that the effects of the present disclosure include all effects that can be inferred from the description of the present disclosure.

As the embodiments of the present disclosure have been described above, those skilled in the art will appreciate that various modifications and alterations are possible through change, deletion or addition of components without departing from the scope and spirit of the present disclosure as described in the accompanying claims, which will also be said to be included within the scope of rights of the present disclosure.

What is claimed is:

1. A method of manufacturing a carbon support, comprising activating a carbon support by reacting the carbon support and an activating gas in a pressure circulation control manner.

2. The method of claim 1, wherein the carbon support comprises any one of the following selected from porous carbon, activated carbon, carbon black, carbon nanotubes, graphene, and any combination thereof.

3. The method of claim 1, wherein the activating gas comprises any one of the following selected from air, oxygen (O₂), carbon dioxide (CO₂), water vapor (H₂O), hydrogen peroxide (H₂O₂), ozone (O₃), and any combination thereof.

4. The method of claim 1, wherein the pressure circulation control manner indicates that a pressure of the activating gas supplied to the carbon support circulates between a lower pressure limit and an upper pressure limit, the lower pressure limit is 0 bar_{g} to 0.1 bar_{g}, and the upper pressure limit is 0.5 bar_{g} to 1 bar_{g}.

5. The method of claim 1, wherein activating the carbon support is performed at a temperature of 800° C. to 1,200° C. for 0.1 to 6 hours.

6. The method of claim 1, further comprising subjecting the carbon support to oxidation heat treatment, before activating the carbon support.

7. The method of claim 6, wherein the oxidation heat treatment comprises a process of oxidizing a surface of the carbon support by reaction with an oxidizing gas.

8. The method of claim 7, wherein the oxidizing gas comprises any one of the following selected from air, oxygen (O₂), carbon dioxide (CO₂), water vapor (H₂O), hydrogen peroxide (H₂O₂), ozone (O₃), and any combination thereof.

9. The method of claim 6, wherein the oxidation heat treatment is performed at a temperature of 150° C. to 600° C. for 0.5 to 5 hours.

10. The method of claim 1, further comprising subjecting an activated carbon support to reduction heat treatment, after activating the carbon support.

11. The method of claim 10, wherein the reduction heat treatment comprises a process of reducing a surface of the activated carbon support by reaction with a reducing gas.

12. The method of claim 11, wherein the reducing gas comprises any one of the following selected from hydrogen (H₂), a mixed gas of hydrogen and inert gas, ammonia (NH₃), and any combination thereof.

13. The method of claim 10, wherein the reduction heat treatment is performed at a temperature of 500° C. to 1,100° C. for 0.1 to 6 hours.

14. The method of claim 11, wherein the reduction heat treatment comprises a process of reducing the surface of the activated carbon support by reacting the activated carbon support and the reducing gas in a pressure circulation control manner.

15. The method of claim 14, wherein the pressure circulation control manner of the reducing gas indicates that a pressure of the reducing gas supplied to the activated carbon support circulates between a lower pressure limit and an upper pressure limit, the lower pressure limit is 0 bar_{g} to 0.1 bar_{g}, and the upper pressure limit is 0.5 bar_{g} to 1 bar_{g}.

16. A method of manufacturing a carbon support, comprising:
(i.) subjecting a carbon support to oxidation heat treatment;
(ii.) activating a pretreated carbon support by reaction with an activating gas; and
(iii.) subjecting an activated carbon support to reduction heat treatment, wherein activating the pretreated carbon support comprises activating the carbon support by reacting the carbon support and the activating gas in a pressure circulation control manner.

17. The method of claim 16, wherein a hydrophilic group is formed on a surface of the carbon support by oxidation heat treatment, and the carbon support is made hydrophobic by removing the hydrophilic group by reduction heat treatment.

18. A catalyst composite for a fuel cell, comprising:
(i.) a carbon support manufactured by activating the carbon support by reacting the carbon support and an activating gas in a pressure circulation control manner; and
(ii.) a catalytic metal supported on the carbon support.
